(19) United States
(12) Patent Application Publication
(10) Pub. No.: US 2025/0236108 A1
(43) Pub. Date: Jul. 24, 2025

(54) LIQUID EJECTION HEAD AND LIQUID EJECTION APPARATUS

(71) Applicants: Tsutoh AOYAMA, KANAGAWA (JP); Gregory John MCAVOY, Greystones (IE)

(72) Inventors: Tsutoh AOYAMA, KANAGAWA (JP); Gregory John MCAVOY, Greystones (IE)

(21) Appl. No.: 19/023,350

(22) Filed: Jan. 16, 2025

(30) Foreign Application Priority Data
Jan. 23, 2024 (JP) 2024-007958

(51) Int. Cl. B41J 2/14

(52) U.S. Cl. CPC B41J 2/14201; B41J 2/1433; B41J 2002/14475; B41J 2202/11

(57) ABSTRACT

A liquid ejection head includes a plurality of nozzles configured to eject liquid; a plurality of individual flow paths respectively communicating with the plurality of nozzles; and a plurality of actuators provided on respective nozzle forming walls of the plurality of individual flow paths. The liquid in the plurality of individual flow paths is ejected from the plurality of nozzles by driving the plurality of actuators. A cross-sectional area of a liquid introduction part into which the liquid is introduced from a common flow path, the cross-sectional area being located on a side of the individual flow path facing the nozzle forming wall, is smaller than a cross-sectional area on a side of the nozzle forming wall of the individual flow path.

### CROSS-REFERENCE TO RELATED APPLICATION

The present application is based on and claims priority under 35 U.S.C. § 119 to Japanese Patent Application No. 2024-007958, filed on Jan. 23, 2024, the contents of which are incorporated herein by reference in their entirety.

### BACKGROUND OF THE PRESENT INVENTION

### 1. Field of the Present Invention

The present invention relates to a liquid ejection head and a liquid ejection apparatus.

### 2. Description of the Related Art

Conventionally, there is known a liquid ejection head that has a plurality of nozzles for ejecting a liquid, a plurality of individual flow paths communicating with the respective plurality of nozzles, and a plurality of actuators provided on respective nozzle formation walls of the plurality of individual flow paths, and the liquid in the individual flow paths is ejected from the nozzles by driving the actuators.

Patent Document 1 describes a liquid ejection head in which, when viewed from a direction orthogonal to both the arrangement direction of the plurality of nozzles and the liquid ejection direction, the width on the nozzle formation wall side of the plurality of individual flow paths, and the width on the liquid introduction part where the liquid is introduced from a common liquid chamber located on the side facing the nozzle formation wall, are the same.
Patent Document 1: Japanese Unexamined Patent Application Publication No. 2019-191184

### SUMMARY OF THE PRESENT INVENTION

According to one aspect of the present invention, there is provided a liquid ejection head including a plurality of nozzles configured to eject liquid; a plurality of individual flow paths respectively communicating with the plurality of nozzles; and a plurality of actuators provided on respective nozzle forming walls of the plurality of individual flow paths, wherein the liquid in the plurality of individual flow paths is ejected from the plurality of nozzles by driving the plurality of actuators, and a cross-sectional area of a liquid introduction part into which the liquid is introduced from a common flow path, the cross-sectional area being located on a side of the individual flow path facing the nozzle forming wall, is smaller than a cross-sectional area on a side of the nozzle forming wall of the individual flow path.

### BRIEF DESCRIPTION OF THE DRAWINGS

FIG. 1 is a cross-sectional view schematically illustrating a nozzle plate vibration type liquid ejection head in an embodiment of the present invention;

FIG. 2 is a perspective view schematically illustrating a nozzle surface of the liquid ejection head in an embodiment of the present invention;

FIG. 3 is a diagram explaining a step of forming a driving circuit and a wiring layer on a flow path substrate according to an embodiment of the present invention;

FIG. 4 is a diagram explaining a step of forming a vibrating film according to an embodiment of the present invention;

FIG. 5 is a diagram explaining a step of forming a first electrode layer, a piezoelectric layer, and a second electrode layer on a vibrating film according to an embodiment of the present invention;

FIG. 6 is a diagram explaining a step of forming a piezoelectric element according to an embodiment of the present invention;

FIG. 7 is a diagram explaining a step of forming a first insulating film according to an embodiment of the present invention;

FIG. 8 is a diagram explaining a step of forming a lead-out wire according to an embodiment of the present invention;

FIG. 9 is a diagram explaining a step of forming a second insulating film according to an embodiment of the present invention;

FIG. 10 is a diagram explaining a step of forming a nozzle forming portion according to an embodiment of the present invention;

FIG. 11 is a diagram explaining a step of forming a nozzle according to an embodiment of the present invention;

FIG. 12 is a diagram explaining a step of forming an individual flow path according to an embodiment of the present invention;

FIG. 13 is a schematic illustration of a printing apparatus that is an inkjet recording apparatus serving as a liquid ejection apparatus in an embodiment of the present invention;

FIG. 14 is a plan illustration of an example of a head unit of the printing apparatus according to an embodiment of the present invention;

FIG. 15 is a plan illustration of a main part of the printing apparatus according to an embodiment of the present invention;

FIG. 16 is a side illustration of a main part of the printing apparatus according to an embodiment of the present invention;

FIG. 17 is a plan illustration of a main part of the liquid ejection unit according to an embodiment of the present invention; and

FIG. 18 is a front view of the liquid ejection unit of the present example according to an embodiment of the present invention.

### DESCRIPTION OF THE EMBODIMENTS

According to Patent Document 1, due to the vibration in the liquid ejection direction of an actuator provided on a nozzle forming wall, there is a possibility that a liquid flow is generated in an individual flow path toward a liquid introduction part and the liquid flows back into a common flow path through the liquid introduction part. The liquid flowing back into the common flow path affects the flow of the liquid to the liquid introduction part of another individual flow path, and there is a possibility that, what is referred to as fluid crosstalk occurs, in which the liquid ejection is disturbed.

The embodiments of the present invention will be described below based on the drawings. Note that a person skilled in the art can easily change and modify the present invention within the scope of the claims to create other embodiments, and these changes and modifications are included in the scope of the claims. The following description is an example of the embodiment of the present invention and does not limit the scope of the claims.

The liquid ejection head in the present embodiment is a nozzle plate vibration type liquid ejection head that ejects liquid in individual flow paths from the nozzles by varying the pressure of the individual flow paths with an actuator provided on a nozzle plate having nozzles. The nozzle plate vibration type has a feature that liquid droplets can be blown with a smaller force than a general UniMorph type piezo head (a device that ejects liquid by vibrating a surface facing a wall (nozzle forming wall) where nozzles communicate in a pressure chamber), and the power saving of the actuator can be achieved.

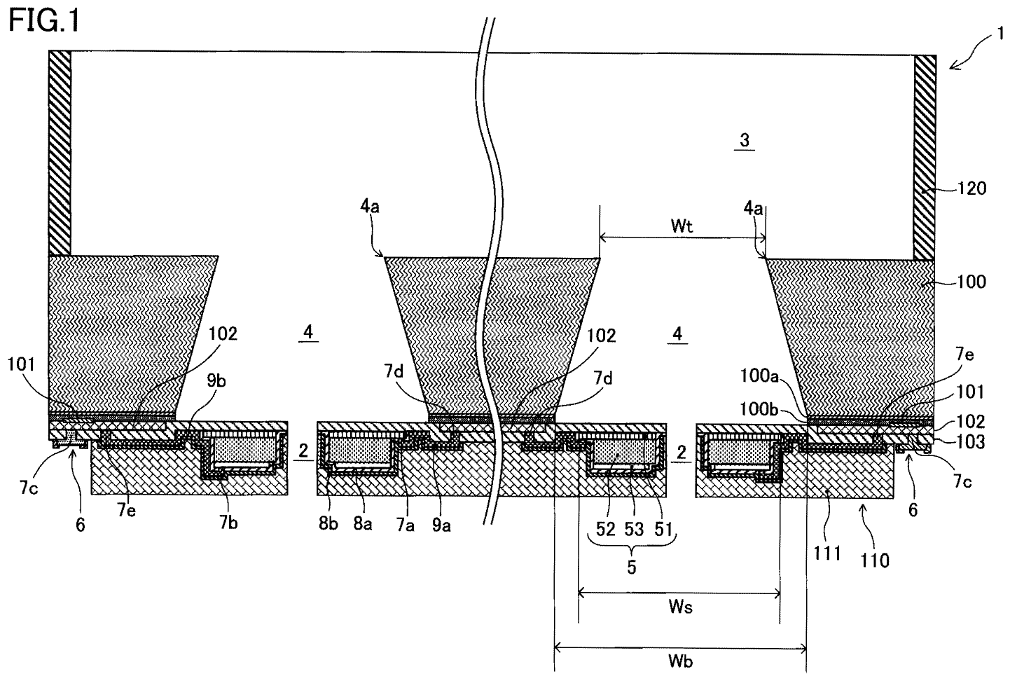

FIG. 1 is a cross-sectional view schematically illustrating a liquid ejection head of the nozzle plate vibration type in the present embodiment.

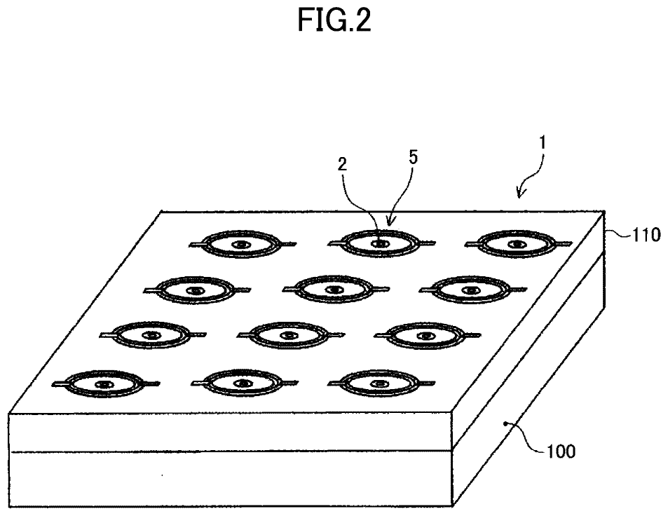

FIG. 2 is a perspective view schematically illustrating a nozzle surface of the liquid ejection head of the present embodiment.

The liquid ejection head 1 includes a nozzle plate 110, an individual flow path substrate 100, and a common flow path substrate 120.

The nozzle plate 110, which forms the nozzle forming wall of the individual flow path, has a thin film shape and includes a plurality of nozzles 2 for ejecting liquid, and a piezoelectric element 5 as an electromechanical conversion element which is an annular actuator arranged around the nozzles 2. The individual flow path substrate 100 has a plurality of individual flow paths 4 communicating with the plurality of nozzles 2. Each individual flow path 4 has a nozzle 2 on one surface, and an opening 4a serving as a liquid introduction part of the individual flow path is arranged on the side facing the one surface. The common flow path substrate 120 has a common flow path 3 communicating with the plurality of individual flow paths 4. At both ends of the liquid ejection head 1, electrical connection pads 6 for connecting with electrical components such as an external power supply are provided.

The individual flow path substrate 100 is an SOI (Silicon on Insulator) substrate having an active layer 100a and a BOX layer 100b, and has a complementary metal-oxide semiconductor (CMOS) 101 and a wiring layer 102 as driving circuits on the side where a vibrating film 103 is formed. The CMOS 101 is provided at both ends of the individual flow path substrate 100 and is a circuit including transistors, resistors, and the like. The wiring layer 102 has a wiring portion for applying a driving waveform to the first electrode 51 of the piezoelectric element 5 and a wiring portion for applying a driving waveform to the second electrode 53 of the piezoelectric element 5. The wiring layer 102 is electrically connected to the electrical connection pad 6 through a third contact 7c opened in the vibrating film 103.

In the wiring layer 102, the portion that forms the wall portion of the individual flow path is removed, in order to facilitate stress control of the vibrating film 103.

By incorporating the CMOS 101 into the individual flow path substrate 100, the mounting process of the driving circuit using another substrate can be reduced, and the area of the external connection portion can be reduced, which leads to the miniaturization of the head. When the CMOS 101 is not incorporated into the individual flow path substrate 100, the individual flow path substrate 100 can be an SI substrate, and the wiring layer 102 is also unnecessary.

The nozzle plate 110 has a nozzle forming portion (film) 111, in which a plurality of nozzles 2 are formed, that covers the piezoelectric element 5. A liquid-repellent film may be formed on the nozzle surface of the nozzle forming portion 111. By forming the liquid-repellent film on the nozzle surface, the liquid can be prevented from adhering to the nozzle surface, and the liquid ejected from the nozzle 2 can be prevented from being affected by the liquid adhering to the nozzle surface.

The piezoelectric element 5 of the nozzle plate 110 has a first electrode 51 (also referred to as a lower electrode), a piezoelectric film 52, and a second electrode 53 (also referred to as an upper electrode). The piezoelectric element 5 is covered with a first insulating film 8a. The first insulating film 8a has a perforated first contact 7a for electrically connecting to the first electrode 51, and a perforated second contact 7b for electrically connecting to the second electrode 53.

The nozzle plate 110 also has a first lead-out wire 9a and a second lead-out wire 9b. The first lead-out wire 9a electrically connects the first electrode 51 of the piezoelectric element 5 to the wiring layer 102 of the individual flow path substrate 100. The second lead-out wire 9b electrically connects the second electrode 53 of the piezoelectric element 5 to the wiring layer 102 of the individual flow path substrate 100.

The first lead-out wire 9a is electrically connected to the first electrode 51 via the first contact 7a and to the wiring layer 102 via a fourth contact 7d. The second lead-out wire 9b is electrically connected to the second electrode 53 via the second contact 7b and to the wiring layer 102 via a fifth contact 7e. The first lead-out wire 9a and the second lead-out wire 9b are covered with a second insulating film 8b. In the present embodiment, the second insulating film 8b also covers the piezoelectric element 5 and has a function of protecting the piezoelectric element 5 by preventing moisture that has entered the nozzle forming portion 111 made of resin from entering the piezoelectric element 5.

The first electrode 51 and the second electrode 53 may be provided with lead-out wire portions, respectively, and electrically connected directly to the wiring layer 102 via the contacts 7d and 7e opened in the vibration film 103. Further, an adhesion improving film may be formed on the second insulating film 8b to ensure adhesion with the nozzle forming portion 111.

The liquid filling the liquid ejection head 1 enters the nozzle 2 and forms a meniscus in the nozzle. When a predetermined driving waveform (voltage) is applied to the electrodes 51 and 53 of the piezoelectric element 5, the piezoelectric film 52 vibrates, and the vibrating film 103 vibrates in the vertical direction in FIG. 1. The vibration of the vibrating film 103 causes a pressure change in the liquid in the individual flow path, and the liquid is ejected from the nozzle 2.

The individual flow path 4 has a round hole shape, and the inner diameter gradually increases from the opening 4a toward the nozzle plate side, so that the inner diameter of the opening 4a serving as the liquid introduction part to which liquid is introduced from the common flow path 3 of the individual flow path 4, is smaller than the inner diameter of the nozzle forming wall (nozzle plate 110) side of the individual flow path. Therefore, as illustrated in FIG. 1, when viewed from the direction orthogonal to the liquid ejection direction, the width Wt of the opening 4a is narrower than the width Wb on the nozzle plate side, and the cross-sectional area of the opening 4a is smaller than the cross-sectional area on the nozzle plate side of the individual flow path 4. The width Wb on the nozzle plate side corresponds to the width of the vibrating part of the vibrating film 103 of the individual flow path 4 as illustrated in FIG. 1, and the cross-sectional area on the nozzle plate side corresponds to the cross-sectional area of the vibrating part of the vibrating film 103 of the individual flow path 4. Thus, because the cross-sectional area of the opening 4a is smaller than the cross-sectional area (the cross-sectional area of the vibrating part) on the nozzle plate side of the individual flow path 4, the flow path resistance of the opening 4a can be increased compared with the case where the cross-sectional area is the same between the opening 4a and the nozzle plate side. Therefore, the flow rate of the liquid passing through the opening 4a can be reduced, and the liquid in the individual flow path flowing toward the opening 4a can be prevented from flowing back to the common flow path 3 through the opening 4a due to the vertical vibration of the piezoelectric element 5 as illustrated in the figure. As a result, fluid crosstalk can be prevented.

The shape of the individual flow path 4 is not limited to a round hole shape, and may be rectangular when viewed from the liquid ejection direction. In the rectangular individual flow path, the width Wt of the opening 4a may be made narrower than the width Wb on the nozzle plate side when viewed from one of the two directions orthogonal to the liquid ejection direction, and the cross-sectional area of the opening 4a may be made smaller than the cross-sectional area on the nozzle plate side.

Further, the cross-sectional area of the opening 4a will suffice as long as it is smaller than the cross-sectional area on the nozzle plate side. For example, the side wall of the individual flow path 4 may have a stepwise shape, the width of the opening 4a may gradually increase toward the nozzle plate side. However, by making the width gradually increase from the opening 4a of the individual flow path 4 toward the nozzle plate side as illustrated in FIG. 1, it is preferable that the cross-sectional area of the opening 4a can be minimized with respect to the cross-sectional area on the nozzle plate side by machining with a Bosch process as described later.

Further, as illustrated in FIG. 1, it is preferable that the width Wt of the opening 4a is made narrower than the width Ws of the piezoelectric element 5 serving as an actuator, and the cross-sectional area of the opening 4a is made smaller than the cross-sectional area of the piezoelectric element 5. As illustrated in FIG. 1, the width Ws of the piezoelectric element 5 is generally made narrower than the width Wb on the nozzle plate side corresponding to the vibration portion of the individual flow path 4, and the cross-sectional area of the piezoelectric element 5 is smaller than the cross-sectional area on the nozzle plate side of the individual flow path 4. Therefore, by making the cross-sectional area of the opening 4a smaller than the cross-sectional area of the piezoelectric element 5, the flow resistance of the opening 4a can be further increased, and the flow rate of the liquid passing through the opening 4a can be further reduced. As a result, the liquid in the individual flow path flowing toward the opening 4a can be further prevented from flowing back to the common flow path 3 through the opening 4a due to the vertical vibration of the piezoelectric element 5 in the figure. As a result, fluid crosstalk can be further prevented.

Next, the method of manufacturing the liquid ejection head of the present embodiment will be described.

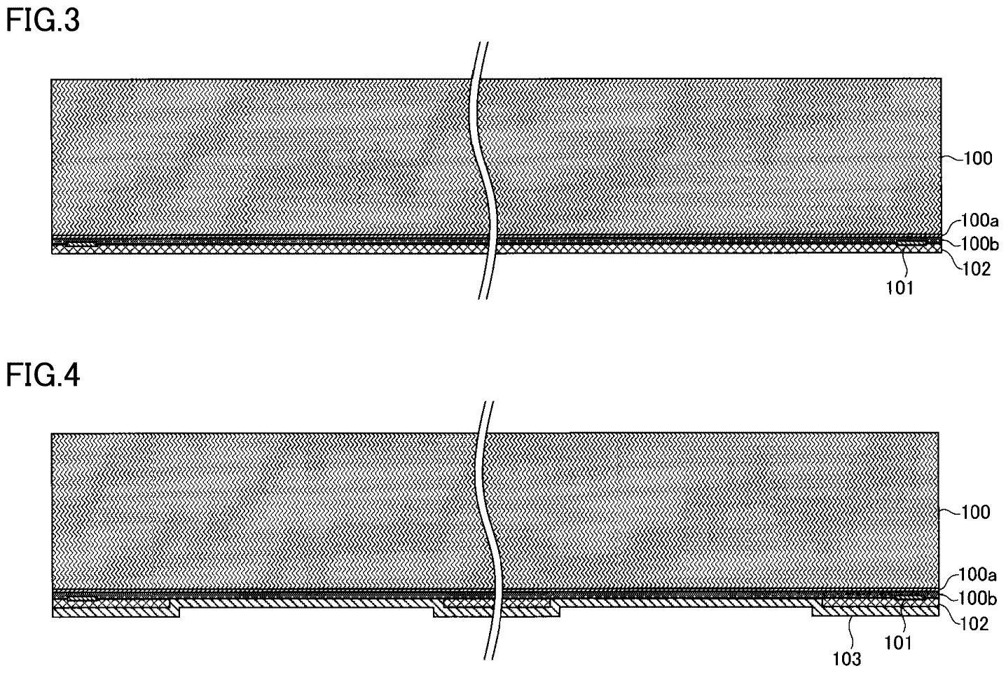

FIGS. 3 to 12 are cross-sectional views illustrating cross sections perpendicular to the arrangement direction of the nozzle holes for explaining the manufacturing process of the liquid ejection head of the present embodiment.

First, as illustrated in FIG. 3, a CMOS 101 serving as a driving circuit including transistors and resistors and a wiring layer 102 are formed on an individual flow path substrate 100 made of an SOI substrate having an active layer 100a and a BOX layer 100b. The wiring layer 102 is formed by a damascene method or the like, and the process of forming and patterning SiO₂ to form grooves, filling the grooves with wiring metal, and covering the grooves with SiO₂ is repeated. Specifically, planarization is performed by CMP polishing, and SiO₂ film formation and patterning are repeated again. This makes it possible to construct fine wiring with a three-dimensional structure.

Next, as illustrated in FIG. 4, the wiring layer 102 corresponding to the part where the piezoelectric material is patterned is removed to form the vibrating film 103. The reason for removing the wiring layer 102 corresponding to the part where the piezoelectric material is patterned is to control the stress of the vibrating film 103. As described above, the SiO₂ of the wiring layer 102 undergoes multiple SiO₂ film formation and polishing steps, which makes it difficult to control the stress of the vibrating film 103. Therefore, the wiring layer 102 corresponding to the part where the piezoelectric material is patterned is removed to form the vibrating film 103. When the stress control is not required, the wiring layer 102 is used as the vibrating film 103, and it is not necessary to form the vibrating film 103.

The material of the vibrating film 103 may be at least an insulating material such as SiO₂, SiN, metal oxide, or resin. However, in order to increase the displacement, a material having a low Young's modulus is desirable, and SiO₂, which has a relatively small difference in the coefficient of linear expansion from that of the individual flow path substrate 100, is most desirable as the material of the vibrating film 103.

Next, as illustrated in FIG. 5, a first electrode layer 151, a piezoelectric layer 152, and a second electrode layer 153 are formed on the vibrating film 103. The first electrode layer 151 and the second electrode layer 153 are preferably metals with low electrical resistance and low reactivity, and metals such as Pt, Ir, and Mo are desirable.

Examples of piezoelectric materials constituting the piezoelectric layer 152 include PZT, AlN, and the like. When the CMOS 101 and the wiring layer 102 are incorporated in the individual flow path substrate 100 to improve density, it is desirable to use a piezoelectric material whose film formation temperature is 450° C. or less in order not to destroy them, and AlN whose film formation temperature is 450° C. or less is preferable.

Further, the following advantages can be obtained by using AlN as the piezoelectric material. Namely, the piezoelectric characteristics can be improved by aligning the crystal orientation of the piezoelectric film 52, but an orientation control layer may be provided between the vibrating film 103 and the first electrode 51 in order to control the orientation. When the piezoelectric material of the piezoelectric film 52 is AlN, the lattice constant of the first electrode 51 made of Mo can be made close to that of AN, by using AlN as the orientation control layer. As a result, the crystal orientation of the piezoelectric film 52 is aligned, and the piezoelectric characteristics can be improved.

The first electrode layer 151, piezoelectric layer 152, and second electrode layer 153 can be formed by a sputtering method or a sol-gel method. In the latter case, because the film formation temperature is high, it is preferable to form the film by a sputtering method when a driving circuit or wiring portion is built in the individual flow path substrate 100.

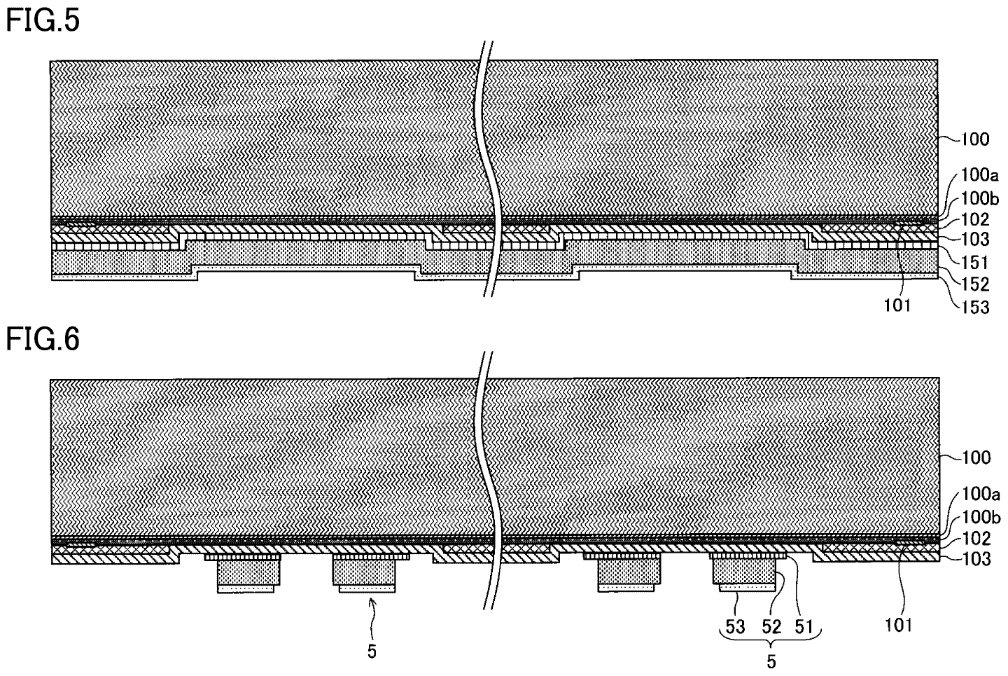

After the first electrode layer 151, piezoelectric layer 152, and second electrode layer 153 are formed, they are molded into suitable shapes to obtain a piezoelectric element 5 consisting of the first electrode 51, piezoelectric film 52, and second electrode 53, as illustrated in FIG. 6. By processing the first electrode layer 151, piezoelectric layer 152, and second electrode layer 153 by photolithography and etching, the first electrode 51, piezoelectric film 52, and second electrode 53 of desired shapes can be easily obtained. There are wet etching and dry etching, but the latter is preferable because dry etching can prevent corrosion of the electrodes 51 and 53 and piezoelectric film 52. After dry etching, residues due to processing tend to remain, so a washing step may be performed after molding to remove residues.

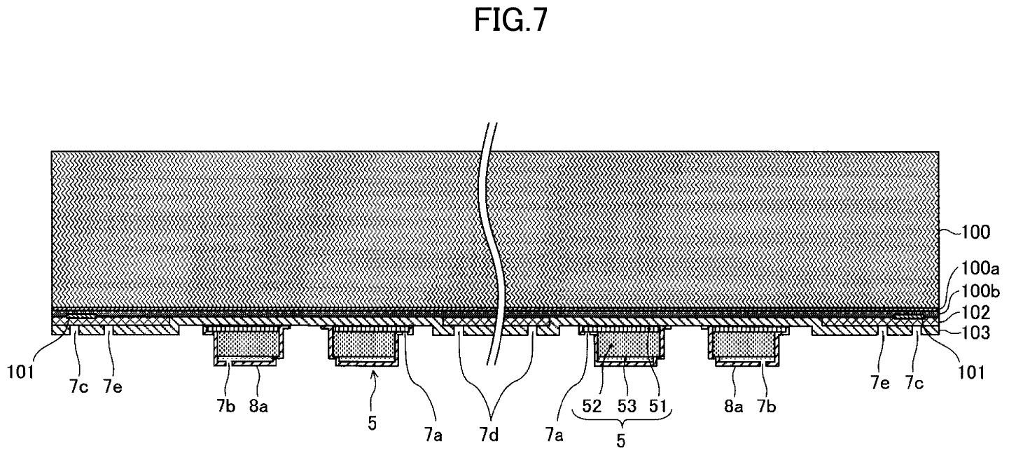

After molding the first electrode 51, piezoelectric film 52, and second electrode 53, a first insulating film 8a is formed as illustrated in FIG. 7. It is preferable that the first insulating film 8a has the same insulating properties as the vibrating film 103, has a small Young's modulus, and has a linear expansion coefficient close to that of the constituent materials. Therefore, it is preferable to use the same SiO₂ as the vibrating film 103. In order to improve reliability, a very thin metal oxide may be used as the material of the first insulating film 8a.

After the first insulating film 8a is formed, the first contact 7a and the second contact 7b are formed in the first insulating film 8a by photolithography and etching, as illustrated in FIG. 7. Further, the third contact 7c, the fourth contact 7d, and the fifth contact 7e are formed in the vibrating film 103.

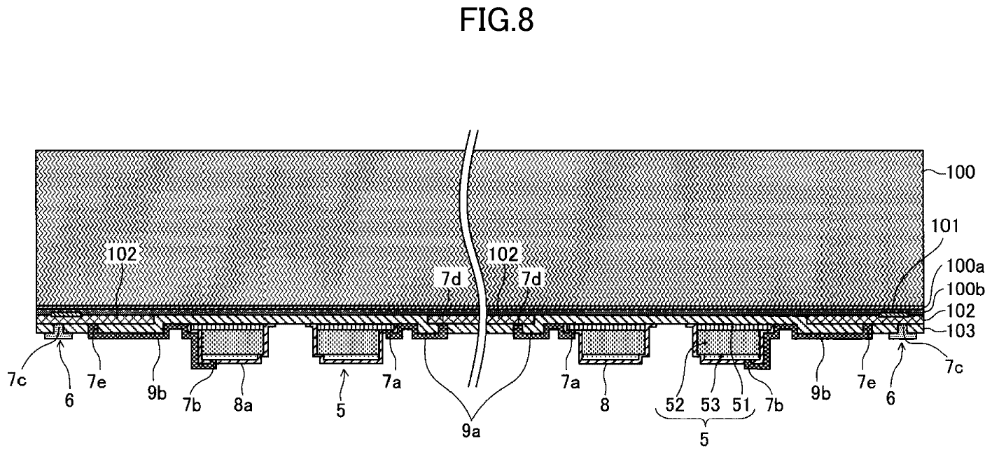

Next, as illustrated in FIG. 8, the first lead-out wire 9a, the second lead-out wire 9b, and the electrical connection pad 6 are formed. Generally, Al or AlCu alloy is used as the material of each lead-out wire 9a and 9b, but precious metal may be used to improve reliability. In this step, the first lead-out wire 9a is electrically connected to the first electrode 51 through the first contact 7a, and is electrically connected to the wiring layer 102 through the fourth contact 7d. The second lead-out wire 9b is electrically connected to the second electrode 53 through the second contact 7b, and is electrically connected to the wiring layer 102 through the fifth contact 7e. The electrical connection pad 6 is electrically connected to the wiring layer 102 through the third contact 7c.

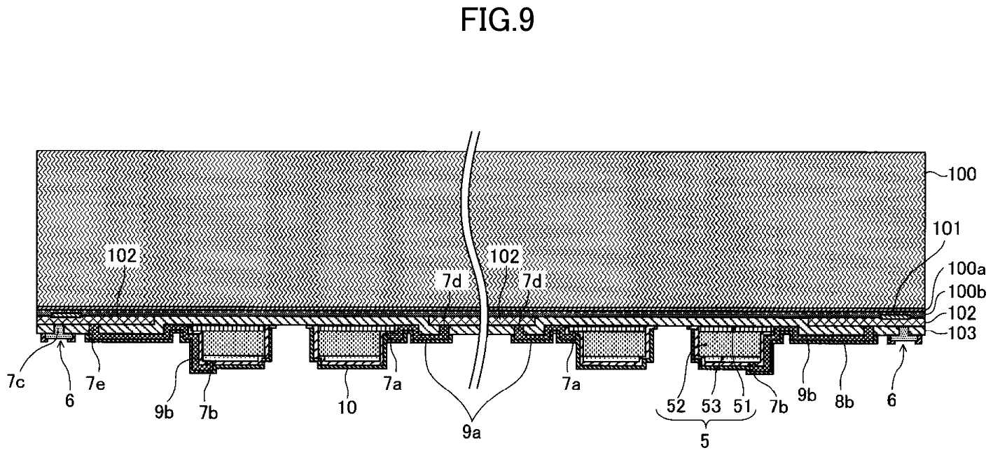

Next, as illustrated in FIG. 9, a second insulating film 8b is formed so as to cover the lead-out wires 9a and 9b, the piezoelectric element 5, and a part of the electrical connection pad 6. SiO₂ may be used for the second insulating film 8b as in the case of the first insulating film 8a, but it is preferable to use SiN, which is widely used as a protective film for semiconductors and has moisture resistance, in order to improve reliability against humidity. Because the second insulating film 8b has two functions, which are insulation and moisture resistance, the nozzle plate 110 can be made thinner than when a moisture-resistant protective film is formed on the second insulating film 8b.

With the above steps, the piezoelectric element 5 can be driven.

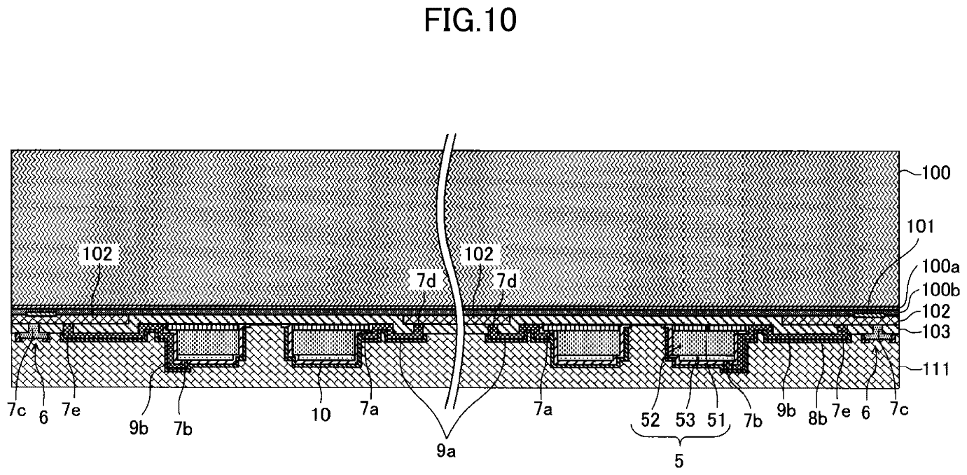

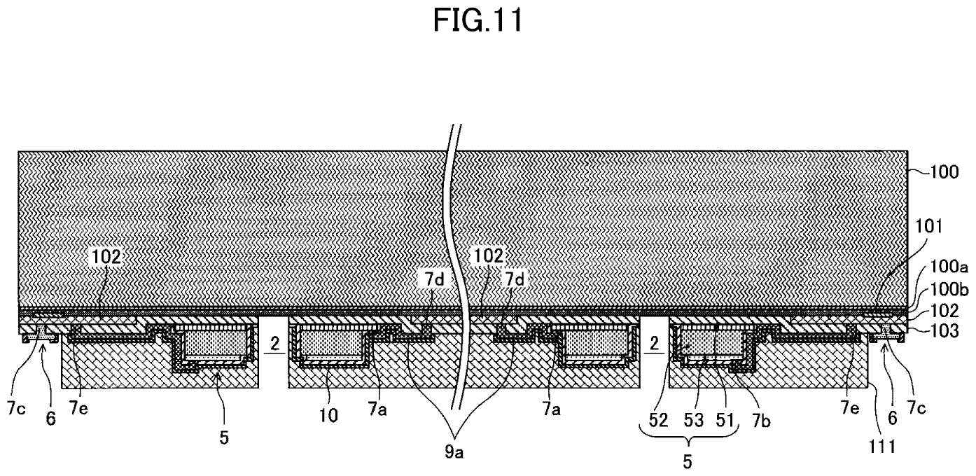

Next, as illustrated in FIG. 10, a nozzle forming portion 111 for forming a nozzle is formed. The nozzle forming portion 111 is formed by spin coating, and it is preferable for the nozzle forming portion 111 to use a resin that can be coated by spin coating, and SU8 or BCB is preferable from the viewpoint of chemical resistance. Then, as illustrated in FIG. 11, the nozzle 2 is formed by etching. The etching of the nozzle 2 is performed by dry etching.

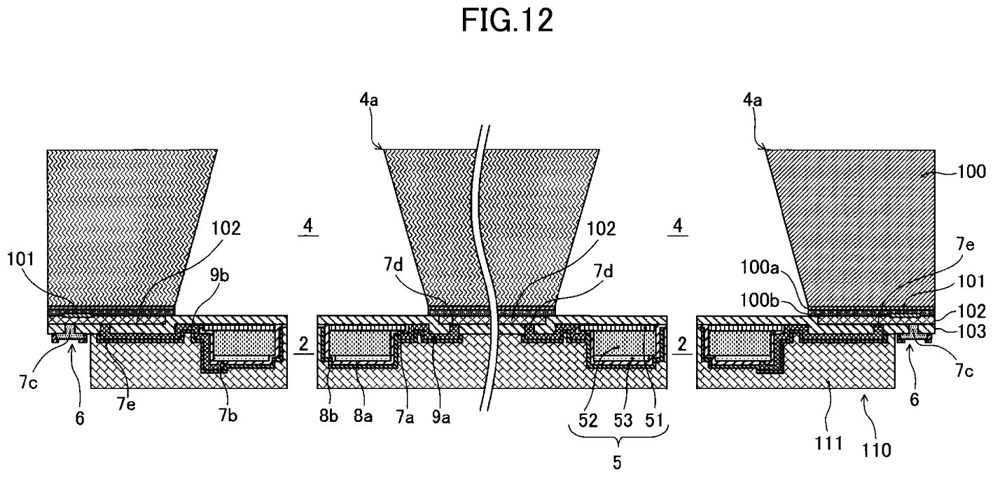

Next, as illustrated in FIG. 12, the individual flow path substrate 100 is processed by Si etching to form a plurality of individual flow paths 4 in the shape of round holes. In this process, the individual flow path 4 in which a cross-sectional area of the opening 4a of the individual flow path 4 is smaller than the cross-sectional area on the nozzle plate side is formed. In the present embodiment, the individual flow path 4 is formed so that the inner diameter gradually increases from the opening 4a toward the nozzle plate side. Therefore, as illustrated in FIG. 12, the wall surface of the individual flow path has a reverse tapered shape in the cross section parallel to the arrangement direction of the nozzles 2.

In order to form the individual flow path 4 having the shape illustrated in FIG. 12, in the present embodiment, machining is performed by using a Bosch process which is a kind of dry etching. The Bosch process is machining in which a series of steps of an isotropic etching step, a protective film formation step, and a protective film removal step of the bottom surface by anisotropic etching, are repeated. In the Bosch process, a vertical hole can be formed by proceeding with machining while protecting the side wall with a protective film. The time of the isotropic etching step is made longer than the time of the previous isotropic etching step, and the machining width of the bottom is made larger than the machining width of the previous isotropic etching step. As a result, as illustrated in FIG. 12, an individual flow path 4 whose inner diameter gradually increases from the opening 4a toward the nozzle plate side is formed, and an individual flow path 4 whose cross-sectional area of the opening 4a is smaller than that on the nozzle plate side is formed.

Next, the verification experiment performed by the inventor of the present invention will be described.

In the verification experiment, the liquid ejection heads of examples 1 to 8 and comparative examples 1 to 4 were prepared by changing the thickness of the individual flow path substrate 100, the inner diameter of the opening 4a of the individual flow path, and the inner diameter on the nozzle plate side of the individual flow path. The examples and comparative examples are as follows.

### Example 1

A 1200 ch liquid ejection head of example 1 was prepared on the individual flow path substrate 100 having a thickness of 200 μm by the manufacturing method described above. The outer diameter of the piezoelectric film 52 in the liquid ejection head of example 1 was 144 μm, the nozzle diameter was 20 μm, the nozzle pitch was 12000 dpi, and the thickness of the column between the individual flow paths 4 on the nozzle plate side was 30 μm. The width Wb (inner diameter) when viewed from the direction orthogonal to the liquid ejection direction on the nozzle plate side of the individual flow path 4 was 180 μm, and the width Wt (inner diameter) when viewed from the direction orthogonal to the liquid ejection direction of the opening 4a of the individual flow path 4 was 124 μm. Wt/Wb=0.689 was satisfied.

### Example 2

The liquid ejection head of example 2 is the same as that of example 1 except that the width Wt (inner diameter) when viewed from the direction orthogonal to the liquid ejection direction of the opening 4a is 179 μm. In example 2, Wt/Wb=0.994 is satisfied.

### Example 3

The liquid ejection head of example 3 is the same as that of example 1 except that the thickness of the individual flow path substrate 100 is 700 μm, and Wt/Wb=0.689 is satisfied.

### Example 4

The liquid ejection head of example 4 is the same as that of example 1 except that the width Wt (inner diameter) when viewed from the direction orthogonal to the liquid ejection direction of the opening 4a is 179 μm, and Wt/Wb=0.994 is satisfied.

### Example 5

The liquid ejection head of example 5 is the same as that of example 1 except that the width Wb (inner diameter) when viewed from the direction orthogonal to the liquid ejection direction on the nozzle plate side is 500 μm, and the width Wt (inner diameter) of the opening 4a is 348 μm, and Wt/Wb=0.696 is satisfied.

### Example 6

The liquid ejection head of example 6 is the same as that of example 5 except that the width Wt (inner diameter) when viewed from the direction orthogonal to the liquid ejection direction of the opening 4a is 498 μm, and Wt/Wb=0.996 is satisfied.

### Example 7

The liquid ejection head of example 7 is the same as that of example 5 except that the thickness of the individual flow path substrate 100 is 700 μm, and Wt/Wb=0.696 is satisfied.

### Example 8

The liquid ejection head of example 8 is the same as that of example 6 except that the thickness of the individual flow path substrate 100 is 700 μm, and Wt/Wb=0.996 is satisfied.

### Comparative Example 1

The liquid ejection head of comparative example 1 is the same as that of example 1 except that the width Wt (inner diameter) when viewed from the direction orthogonal to the liquid ejection direction of the opening 4a is 180 μm and Wt/Wb=1 is satisfied.

### Comparative Example 2

The liquid ejection head of comparative example 2 is the same as that of example 3 except that the width Wt (inner diameter) when viewed from the direction orthogonal to the liquid ejection direction is 180 μm and Wt/Wb=1 is satisfied.

### Comparative Example 3

The liquid ejection head of comparative example 3 is the same as example 5 except that the width Wt (inner diameter) when viewed from the direction orthogonal to the liquid ejection direction is 500 μm and Wt/Wb=1 is satisfied.

### Comparative Example 4

The liquid ejection head of comparative example 4 is the same as example 7 except that the width Wt (inner diameter) when viewed from the direction orthogonal to the liquid ejection direction is 500 μm and Wt/Wb=1 is satisfied.

The effect on crosstalk was investigated for the liquid ejection heads of examples 1 to 8 and comparative examples 1 to 4. First, the ejection speed V of the droplets ejected from the nozzle when only the piezoelectric element of the target channel is driven, and the ejection speed V′ of the target channel when this target channel and other channels around the target channel are driven simultaneously were measured. The ejection speed V′ was measured when the 100 ch around the target channel were driven simultaneously, when the 600 ch were driven simultaneously, and when all 1200 ch were driven simultaneously. Then, the effect on crosstalk was examined by using the ejection speed V and the ejection speed V′.

When crosstalk occurs, the ejection efficiency decreases, so V′<V or (V′/V)<1 is satisfied. In this verification experiment, if (V′/V)×100≥60% is satisfied, it is determined to be acceptable because the effect on the image is small. The verification results are indicated in table 1 below.

TABLE 1

| | THICKNESS OF | | | | WHEN DRIVING | WHEN DRIVING | WHEN DRIVING |
|---|---|---|---|---|---|---|---|
| | SUBSTRATE | Wb | Wt | | 100 ch | 600 ch | 1200 ch |
| | [μm] | [μm] | [μm] | Wt/Wb | V′/V × 100 | V′/V × 100 | V′/V × 100 |
| COMPARATIVE | 200 | 180 | 180 | 1.000 | 69% | 56% | 38% |
| EXAMPLE 1 | | | | | | | |
| EXAMPLE 1 | 200 | 180 | 124 | 0.689 | 95% | 94% | 95% |
| EXAMPLE 2 | 200 | 180 | 179 | 0.994 | 73% | 68% | 63% |
| COMPARATIVE | 700 | 180 | 180 | 1.000 | 71% | 60% | 44% |
| EXAMPLE 2 | | | | | | | |
| EXAMPLE 3 | 700 | 180 | 124 | 0.689 | 97% | 98% | 96% |
| EXAMPLE 4 | 700 | 180 | 179 | 0.994 | 79% | 71% | 65% |
| COMPARATIVE | 200 | 500 | 500 | 1.000 | 55% | 42% | 16% |
| EXAMPLE 3 | | | | | | | |
| EXAMPLE 5 | 200 | 500 | 348 | 0.696 | 92% | 90% | 89% |
| EXAMPLE 6 | 200 | 500 | 498 | 0.996 | 76% | 72% | 61% |
| COMPARATIVE | 700 | 500 | 500 | 1.000 | 65% | 54% | 25% |
| EXAMPLE 4 | | | | | | | |
| EXAMPLE 7 | 700 | 500 | 348 | 0.696 | 90% | 92% | 91% |
| EXAMPLE 8 | 700 | 500 | 498 | 0.996 | 79% | 74% | 60% |

As can be seen from Table 1, comparative examples 1 to 4, in which the width Wt (inner diameter) of the opening 4a of the individual flow path and the width Wb (inner diameter) on the nozzle plate side of the individual flow path are the same (Wt/Wb=1) and the cross-sectional area of the opening 4a and the cross-sectional area on the nozzle plate side are the same (Wt/Wb=1), failed because the ratio of the ejection speed ((V′/V)×100%) during 1200 ch simultaneous driving was less than 60%.

On the other hand, in examples 1 to 8, in which the width Wt (inner diameter) of the opening 4a of the individual flow path is less than the width Wb (inner diameter) on the nozzle plate side of the individual flow path ((Wt/Wb)<1) and the cross-sectional area of the opening 4a is smaller than the cross-sectional area on the nozzle plate side, the ratio of the ejection speed ((V′/V)×100%) was greater than or equal to 60%. Thus, it was confirmed that crosstalk can be prevented by making the cross-sectional area of the opening 4a smaller than the cross-sectional area on the nozzle plate side.

In examples 1, 3, 5, and 7 in which (Wt/Wb) is approximately 0.70, the ratio of the ejection speed ((V′/V)×100%) is 90% or more for each of the 100 ch simultaneous drive, 600 ch simultaneous drive, and 1200 ch simultaneous drive, and it was confirmed that crosstalk can be prevented satisfactorily.

In examples 1, 3, 5, and 7, (Wt/Wb) is approximately 0.70. This is because, when (Wt/Wb) is less than approximately 0.70, in the formation of the individual flow paths 4 by the Bosch process described above, there will be some areas where etching gas does not enter, and etching failure occurs. Therefore, when (Wt/Wb) is approximately 0.70 or more, the individual flow paths 4 can be formed satisfactorily with at least a substrate thickness of 700 μm or less.

From the above verification experiments, in a liquid ejection head having a substrate thickness of 200 μm or more and 700 μm or less and a width Wb (inner diameter) of 180 μm to 500 μm when viewed from the direction orthogonal to the liquid ejection direction on the nozzle plate side of the individual flow path, if (Wt/Wb) is at least 0.70 μm or more and 0.99 μm or less, ((V′/V)×100%) can be 60% or more, and image disturbance due to crosstalk can be kept within an acceptable range.

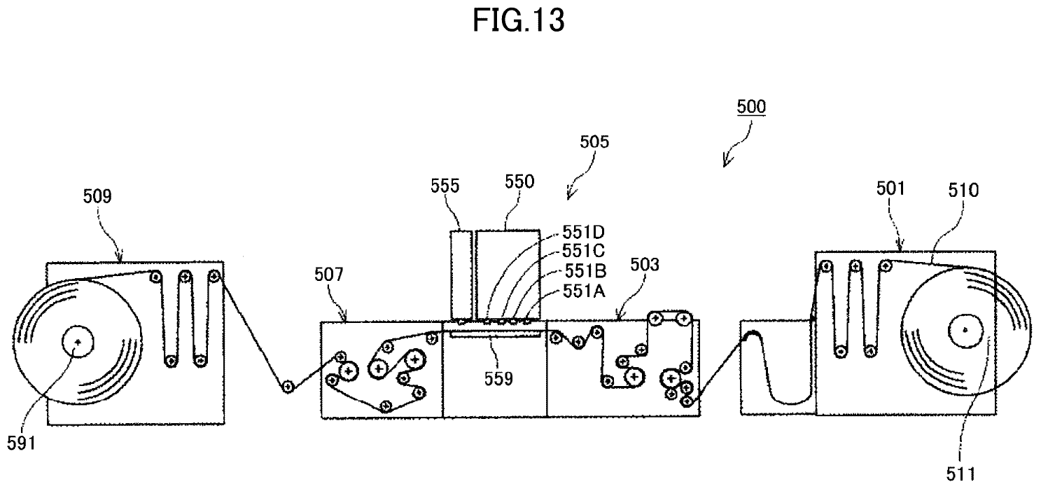

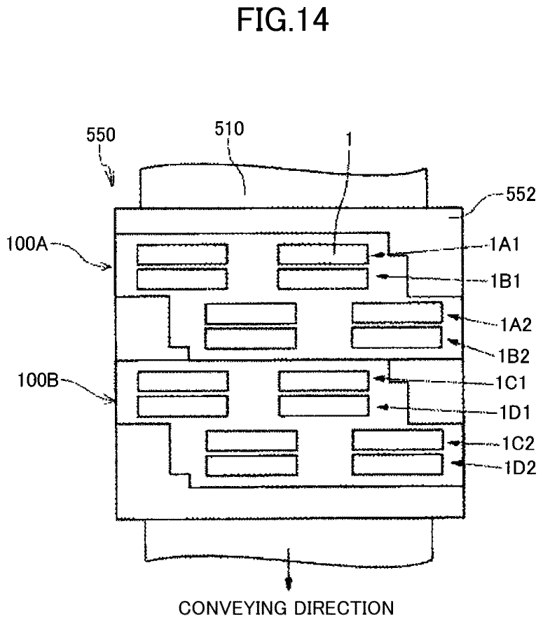

Next, an example of a liquid ejection apparatus according to the present invention will be described with reference to FIGS. 13 and 14.

FIG. 13 is a schematic explanatory view of a printing apparatus which is an inkjet recording apparatus serving as a liquid ejection apparatus according to the present embodiment.

FIG. 14 is a plan explanatory view of an example of a head unit of the printing apparatus according to the present embodiment.

A printing apparatus 500 which is a liquid ejection apparatus includes a carry-in means 501 for carrying in a continuum 510, and a guide conveyance means 503 for guiding and conveying the continuum 510 carried in from the carry-in means 501 to the printing means 505. The printing apparatus 500 also includes a printing means 505 for printing by ejecting liquid to the continuum 510 to form an image, a drying means 507 for drying the continuum 510, and a carry-out means 509 for conveying the continuum 510.

The continuum 510 is fed from a main winding roller 511 of the carry-in means 501, guided and conveyed by rollers of the carry-in means 501, the guide conveyance means 503, the drying means 507, and the carry-out means 509, and wound up by a winding roller 591 of the carry-out means 509. The continuum 510 is conveyed on the conveyance guide member 559 in the printing means 505 facing the head unit 550, and an image is printed by the liquid ejected from the head unit 550.

In the printing apparatus 500 of the present embodiment, the head unit 550 is provided with the two head modules 100A and 100B according to the present embodiment in a common base member 552.

When the arrangement direction of the liquid ejection heads 1 in the direction orthogonal to the conveying direction of the head modules 100A and 100B is the head arrangement direction, the liquid of the same color is ejected from the head rows 1A1 and 1A2 of the head module 100A. Similarly, the liquid of the required color is ejected from the head rows 1B1 and 1B2 of the head module 100A as a set, the head rows 1C1 and 1C2 of the head module 100B as a set, and the head rows 1D1 and 1D2 of the head module 100B as a set.

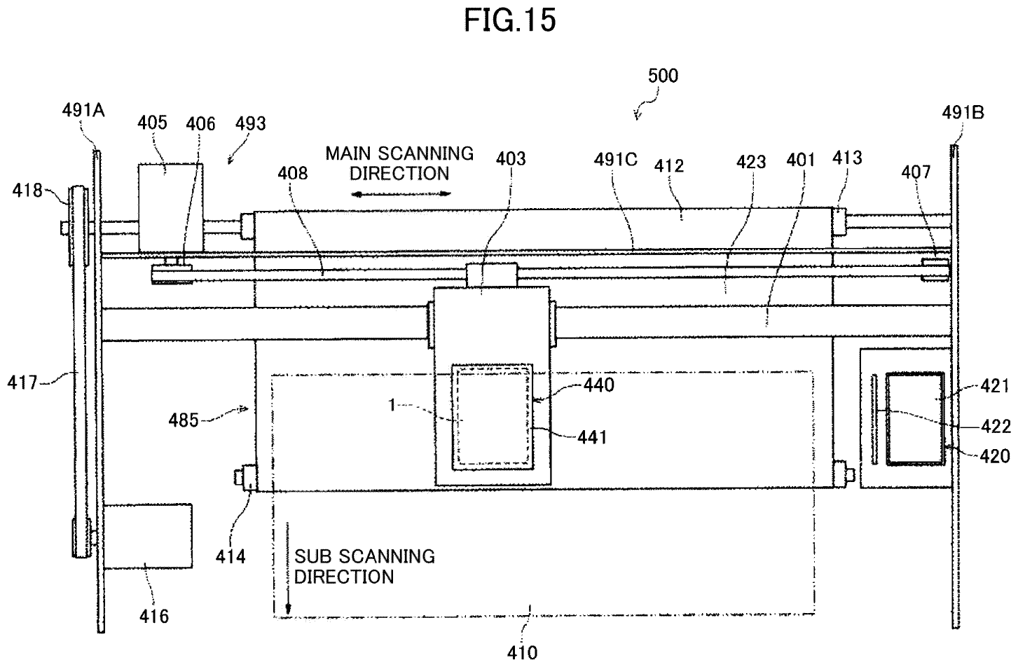

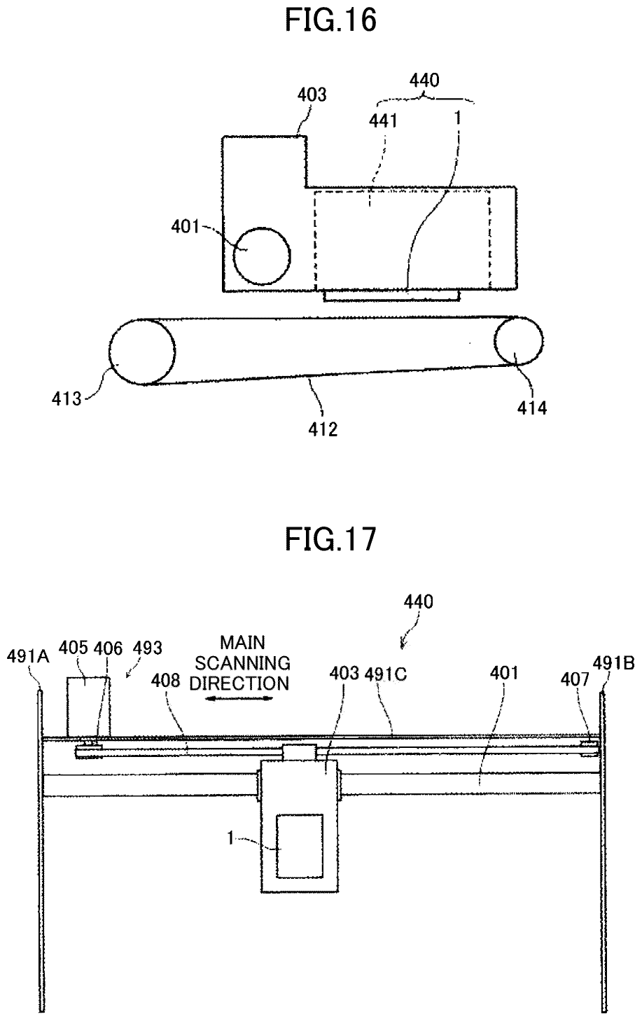

Next, another example of the printing apparatus serving as a liquid ejection apparatus according to the present invention will be described with reference to FIGS. 15 and 16.

FIG. 15 is a plan view of a main part of the printing apparatus of the present example.

FIG. 16 is a side view of a main part of the printing apparatus of the present example.

The printing apparatus 500 of the present example is a serial type apparatus, and a carriage 403 is moved back and forth in the main scanning direction by a main scanning moving mechanism 493. The main scanning moving mechanism 493 includes a guide member 401, a main scanning motor 405, a timing belt 408, etc. The guide member 401 is passed over left and right side plates 491A and 491B to hold the carriage 403 movably. Then, the carriage 403 is moved back and forth in the main scanning direction by a main scanning motor 405 via the timing belt 408 passed between the driving pulley 406 and the driven pulley 407.

The carriage 403 is mounted with a liquid ejection unit 440 integrating the liquid ejection head 1 according to an embodiment of the present invention and a head tank 441. The liquid ejection head 1 ejects liquids of, for example, yellow (Y), cyan (C), magenta (M), and black (K) colors. The liquid ejection head 1 has a nozzle array consisting of a plurality of nozzles arranged in the sub-scanning direction orthogonal to the main scanning direction, and is mounted so that the ejection direction is downward. The liquid ejection head 1 is connected to a liquid circulation device and circulates and supplies a liquid of a required color.

The printing apparatus 500 has a conveying mechanism 495 for conveying paper 410. The conveying mechanism 495 includes a conveyance belt 412 as a conveyance means and a sub-scanning motor 416 for driving the conveyance belt 412. The conveyance belt 412 attracts the paper 410 and conveys it at a position facing the liquid ejection head 1. The conveyance belt 412 is an endless belt and is hung between a conveyance roller 413 and a tension roller 414. The attraction can be electrostatic attraction or air suction. The conveyance belt 412 circulates in the sub-scanning direction by rotationally driving the conveyance roller 413 through the timing belt 417 and the timing pulley 418 with the sub-scanning motor 416.

Further, on one side of the carriage 403 in the main scanning direction, a maintenance recovery mechanism 420 for maintaining and recovering the liquid ejection head 1 is arranged on the side of the conveyance belt 412. The maintenance recovery mechanism 420 includes, for example, a cap member 421 for capping the nozzle surface of the liquid ejection head 1 and a wiper member 422 for wiping the nozzle surface. The main scanning moving mechanism 493, the maintenance recovery mechanism 420, and the conveying mechanism 495 are attached to a housing including side plates 491A and 491B, and a back plate 491C.

In the printing apparatus 500 configured as described above, the paper 410 is fed onto and attracted to the conveyance belt 412, and the paper 410 is conveyed in the sub-scanning direction by the circumferential movement of the conveyance belt 412. Thus, the liquid ejection head 1 is driven in response to an image signal while moving the carriage 403 in the main scanning direction, thereby ejecting liquid to the stopped paper 410 to form an image.

Next, another example of the liquid ejection unit according to the present invention will be described with reference to FIG. 17.

FIG. 17 is a plan view of a main part of the liquid ejection unit of the present example.

The liquid ejection unit 440 is composed of a housing portion consisting of side plates 491A and 491B and a back plate 491C, a main scanning moving mechanism 493, a carriage 403, and the liquid ejection head 1 among the members constituting the liquid ejection apparatus.

It is also possible to construct a liquid ejection unit in which the aforementioned maintenance recovery mechanism 420 is further attached to, for example, the side plate 491B of the liquid ejection unit 440.

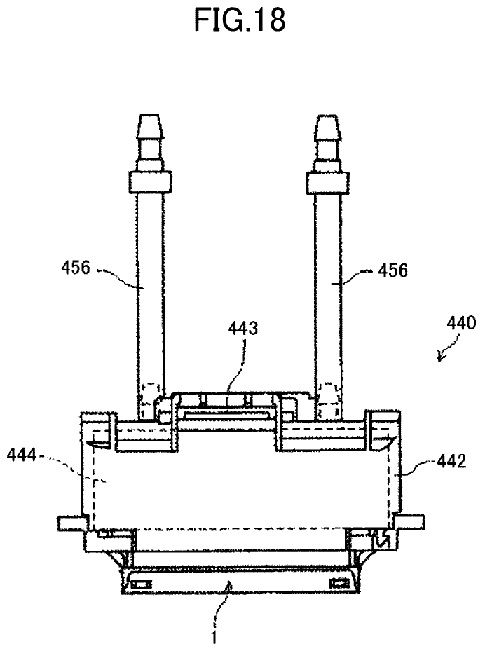

Next, another example of the liquid ejection unit according to the present invention will be described with reference to FIG. 18.

FIG. 18 is a front view of the liquid ejection unit of the present example.

The liquid ejection unit 440 comprises a liquid ejection head 1 to which a flow path component 444 is attached, and a tube 456 connected to the flow path component 444.

The flow path component 444 is arranged inside the cover 442. A head tank 441 may be included instead of the flow path component 444. Further, a contact 443 for electrically connecting to the liquid ejection head 1 is provided above the flow path component 444.

In the present application, the liquid to be ejected may have a viscosity and a surface tension capable of being ejected from the head, and although not particularly limited, it is preferable that the viscosity is 30 mPa·s or less under normal temperature and pressure, or by heating and cooling. More specifically, they are solutions, suspensions, emulsions and the like containing solvents such as water and organic solvents, colorants such as dyes and pigments, function-imparting materials such as polymerizable compounds, resins, and surfactants, biocompatible materials such as DNA, amino acids, proteins, and calcium, and edible materials such as natural pigments. These can be used, for example, in inkjet inks, surface treatment solutions, solutions for forming components of electronic devices and light-emitting devices and electronic circuit resist patterns, and material solutions for three-dimensional molding.

Examples of energy sources for ejecting liquid include those using piezoelectric actuators (laminated piezoelectric elements and thin-film piezoelectric elements), thermal actuators using electrothermal conversion elements such as heating resistors, and electrostatic actuators consisting of a diaphragm and counter electrodes.

A liquid ejection unit is a liquid ejection head integrated with functional components and mechanisms, and includes an assembly of components related to ejecting liquid. For example, a liquid ejection unit includes a liquid ejection head combined with at least one of the following components: a head tank, a carriage, a supply mechanism, a maintenance recovery mechanism, a main scanning moving mechanism, and a liquid circulation device.

Here, integration includes, for example, a liquid ejection head, a functional component, or a mechanism that are fixed to each other by fastening, bonding, or engaging, or such that one is held movably with respect to the other. Further, the liquid ejection head, the functional component, or the mechanism may be detachably configured.

For example, there is a liquid ejection unit in which a liquid ejection head and a head tank are integrated. Also, here is a liquid ejection unit in which a liquid ejection head and a head tank are integrated by being connected to each other by a tube or the like. Here, a unit including a filter can be added between the head tank of these liquid ejection units and the liquid ejection head.

Also, there is a liquid ejection unit in which a liquid ejection head and a carriage are integrated.

Also, there is a liquid ejection unit in which the liquid ejection head and the scanning moving mechanism are integrated by movably holding the liquid ejection head with a guide member constituting a part of the scanning moving mechanism. Also, there is a liquid ejection unit in which a liquid ejection head, the carriage, and the main scanning moving mechanism are integrated.

As a liquid ejection unit, a cap member which is a part of a maintenance recovery mechanism is fixed to a carriage to which a liquid ejection head is attached, and the liquid ejection head, carriage, and maintenance recovery mechanism are integrated.

There is a liquid ejection unit in which a tube is connected to a liquid ejection head, to which a head tank or flow path component is attached, and the liquid ejection head and a supply mechanism are integrated. Through this tube, the liquid of the liquid storage source is supplied to the liquid ejection head.

The main scanning moving mechanism includes a single guide member. The supply mechanism includes a single tube and a single loading unit.

Although the “liquid ejection unit” is described here in combination with the liquid ejection head, the “liquid ejection unit” includes a liquid ejection unit in which a head module or head unit including the above-mentioned liquid ejection head is integrated with the above-mentioned functional components and mechanisms.

The “liquid ejection apparatus” includes a device including a liquid ejection head, a liquid ejection unit, a head module, a head unit, etc., and drives the liquid ejection head to eject liquid. The liquid ejection apparatus includes not only a device capable of ejecting liquid to an object on which liquid can adhere, but also a device for ejecting liquid into air or liquid.

The “liquid ejection apparatus” may also include a means related to feeding, conveying, and ejecting of an object on which liquid can adhere, as well as pre-processing devices and post-processing devices.

For example, the “liquid ejection apparatus” includes an image forming device that forms an image on paper by ejecting ink, and a three-dimensional molding device that ejects a molding liquid into a powder layer formed by layering powder to form a three-dimensional molding.

The “liquid ejection apparatus” is not limited to a device in which significant images such as characters and figures are visualized by the ejected liquid. For example, devices that form patterns or the like that have no meaning by themselves, and devices that form three-dimensional images, are also included.

The above-mentioned “an object on which liquid can adhere” means a material to which liquid can be adhered at least temporarily, and to which liquid attaches and adheres, and to which liquid adheres and permeates, etc. Specific examples include media on which information is recorded such as paper sheets, recording paper, a film, and a cloth, electronic components such as electronic substrates and piezoelectric elements, powder layers, organ models, test cells, etc., and all media to which liquid can adhere are included unless specifically limited.

The material of the above-mentioned “an object on which liquid can adhere” may be paper, yarn, fiber, fabric, leather, metal, plastic, glass, wood, ceramics, etc., as long as liquid can be adhered even temporarily.

The “liquid ejection apparatus” includes a device in which the liquid ejection head and the object on which liquid can adhere relatively move, but is not limited thereto. Specific examples include a serial type device in which the liquid ejection head moves and a line type device in which the liquid ejection head does not move.

Another “liquid ejection apparatus” includes a processing liquid application device in which a processing liquid is ejected onto a paper in order to apply the processing liquid to the surface of the paper for the purpose of modifying the surface of the paper. There is also a jet granulation device in which the composition liquid in which the raw material is dispersed in the solution is jetted through a nozzle to granulate the fine particles of the raw material.

In the terminology of the present application, image formation, recording, printing, copying, printing, molding, and the like are all synonymous.

Although the preferred embodiments of the present invention have been described above, the present invention is not limited to the specific embodiments, and various modifications and changes can be made within the scope of the purpose of the present invention described in the claims, unless otherwise limited by the above description.

The above-described embodiments are only examples, and each of the following modes has a unique effect.

### Mode 1

The liquid ejection head 1 is provided with a plurality of nozzles 2 for ejecting liquid, a plurality of individual flow paths 4 communicating with the plurality of nozzles 2, and a plurality of actuators such as piezoelectric elements 5 provided on the respective nozzle formation walls of the plurality of individual flow paths 4, and drives the actuators to eject liquid in the individual flow paths from the nozzles 2, wherein the cross-sectional area of the liquid introduction part such as the opening 4a to which liquid is introduced from the common flow path 3, on the side of the individual flow path 4 facing the nozzle formation wall, is smaller than the cross-sectional area on the nozzle formation wall side of the individual flow path 4.

According to this, as described in the embodiment, by making the cross-sectional area of the liquid introduction part to which liquid is introduced from the common flow path smaller than the cross-sectional area on the nozzle formation wall side of the individual flow path, the flow resistance of the liquid introduction part can be increased compared with the case where the cross-sectional area of the liquid introduction part is the same as the cross-sectional area on the nozzle formation wall side of the individual flow path, and the flow rate of the liquid through the liquid introduction part can be reduced. Thus, the liquid flowing away from the nozzle due to the vibration of the actuator in the liquid ejection direction can be prevented from flowing back to the common flow path through the liquid introduction part. Thus, fluid crosstalk can be prevented.

### Mode 2

In mode 1, when Wb is the width of the nozzle formation wall side, which is the nozzle plate 110 side of the individual flow path 4 when viewed from the direction orthogonal to the liquid ejection direction, and Wt is the width of the liquid introduction part such as the opening 4a, 0.7≤Wt/Wb<0.99 is satisfied.

According to this, as described in the verification experiment, as compared with the comparative examples 1 to 4 in which Wt/Wb=1, reduction of ejection efficiency due to crosstalk can be prevented.

### Mode 3

In mode 2, the width Wb of the nozzle formation wall side is 180 μm or more and 500 μm or less.

According to this, as described in the verification experiment, as long as the width Wb of the nozzle formation wall side is 180 μm or more and 500 μm or less, reduction of ejection efficiency due to crosstalk can be prevented.

### Mode 4

In mode 2 or 3, the thickness of the individual flow path substrate 100 in which the plurality of individual flow paths 4 are formed is 200 μm or more and 700 μm or less.

According to this, as described in the verification experiment, at least in the range where the thickness of flow path substrate is 200 μm or more and 700 μm or less, reduction of the ejection efficiency due to crosstalk can be prevented.

### Mode 5

In any of modes 1 to 4, the cross-sectional area of the liquid introduction part such as the opening 4a is smaller than the cross-sectional area of the vibrating portion of the vibrating film 103 on the nozzle forming wall side.

According to this, as described in the embodiment, compared with the case where the cross-sectional area of the liquid introduction part such as the opening 4a is the same as the cross-sectional area of the vibrating portion of the vibrating film 103 of the individual flow path 4, the flow resistance of the liquid introduction part can be increased and the flow rate of the liquid through the liquid introduction part can be reduced. Thus, the liquid flowing away from the nozzle due to the vibration of the actuator in the liquid ejection direction can be prevented from flowing back to the common flow path through the liquid introduction part. Thus, the fluid crosstalk can be prevented.

### Mode 6

In any of the modes 1 to 5, the cross-sectional area of the liquid introduction part such as the opening 4a is smaller than the cross-sectional area of the actuator such as the piezoelectric element 5.

According to this, as described in the embodiment, compared with the case where the cross-sectional area of the liquid introduction part such as the opening 4a is the same as the cross-sectional area of the vibration portion of the actuator such as the piezoelectric element 5, the flow path resistance of the liquid introduction part can be increased, and the flow rate of the liquid through the liquid introduction part can be reduced. Thus, the liquid flowing away from the nozzle due to the vibration of the actuator in the liquid ejection direction can be prevented from flowing back to the common flow path through the liquid introduction part. Thus, the fluid crosstalk can be prevented.

### Mode 7

In any of modes 1 to 6, the plurality of individual flow paths 4 are formed by the Bosch process.

According to this, as described in the embodiment, the individual flow paths 4 can be easily formed in which the cross-sectional area of the liquid introduction part such as the opening 4a is smaller than the cross-sectional area of the nozzle forming wall side.

### Mode 8

In mode 7, the individual flow path substrate 100 in which the plurality of individual flow paths 4 are formed has a driving circuit such as a CMOS 101 for applying a voltage to the actuator such as the piezoelectric element 5.

According to this, as described in the embodiment, this eliminates the need to mount a separate substrate having a driving circuit. Thus, the area of the external connection portion can be reduced, and the head can be miniaturized.

### Mode 9

In mode 8, the actuator such as the piezoelectric element 5 is formed at a temperature of 450° C. or less.

According to this, as described in the embodiment, the driving circuit of the flow path substrate can be prevented from being destroyed by the heat during the film formation of the actuator such as the piezoelectric element 5.

### Mode 10

In mode 9, an actuator such as a piezoelectric element 5 is formed by sputtering.

According to this, as described in the embodiment, the film formation temperature can be reduced as compared with the case where the film is formed by the sol-gel method, and the driving circuit of the flow path substrate can be prevented from being destroyed by the heat during the film formation.

### Mode 11

A liquid ejection apparatus includes the liquid ejection head according to any of modes 1 to 10.

Accordingly, the liquid can be ejected satisfactorily.

According to the present invention, fluid crosstalk can be prevented.

The liquid ejection head and the liquid ejection apparatus are not limited to the specific embodiments described in the detailed description, and variations and modifications may be made without departing from the spirit and scope of the present invention.

What is claimed is:

1. A liquid ejection head comprising:
a plurality of nozzles configured to eject liquid;
a plurality of individual flow paths respectively communicating with the plurality of nozzles; and
a plurality of actuators provided on respective nozzle forming walls of the plurality of individual flow paths, wherein
the liquid in the plurality of individual flow paths is ejected from the plurality of nozzles by driving the plurality of actuators, and
a cross-sectional area of a liquid introduction part into which the liquid is introduced from a common flow path, the cross-sectional area being located on a side of the individual flow path facing the nozzle forming wall, is smaller than a cross-sectional area on a side of the nozzle forming wall of the individual flow path.

2. The liquid ejection head according to claim 1, wherein
when a width of the individual flow path on the side of the nozzle forming wall is given as Wb and a width of the liquid introduction part is given as Wt, as viewed from a direction orthogonal to a liquid ejection direction, a formula 0.7≤Wt/Wb<0.99 is satisfied.

3. The liquid ejection head according to claim 2, wherein the width Wb of the individual flow path on the side of the nozzle forming wall is 180 μm or more and 500 μm or less.

4. The liquid ejection head according to claim 2, a thickness of a flow path substrate in which the plurality of individual flow paths are formed is 200 μm or more and 700 μm or less.

5. The liquid ejection head according to claim 1, wherein the cross-sectional area of the liquid introduction part is smaller than a cross-sectional area of a vibration portion of a vibration film on the side of the nozzle forming wall.

6. The liquid ejection head according to claim 1, wherein the cross-sectional area of the liquid introduction part is smaller than a cross-sectional area of the actuator.

7. The liquid ejection head according to claim 1, wherein the plurality of individual flow paths are formed by a Bosch process.

8. The liquid ejection head according to claim 7, wherein a flow path substrate in which the plurality of individual flow paths are formed has a driving circuit for applying a voltage to the actuator.

9. The liquid ejection head according to claim 8, wherein the actuator is formed at a temperature of 450° C. or less.

10. The liquid ejection head according to claim 9, wherein the actuator is formed by sputtering.

11. A liquid ejection apparatus comprising:
the liquid ejection head according to claim 1.
